(19) United States
(12) Patent Application Publication
(10) Pub. No.: US 2009/0313100 A1
(43) Pub. Date: Dec. 17, 2009

(54) SYSTEM AND METHOD FOR PREVIEWING SEARCH RESULTS

(75) Inventor: Vikram Vijaykumar Ingleshwar, Solapur (IN)

Correspondence Address: Law Office of Robert Bolan, P.O. Box 36, Bellevue, WA, 98009, US

(73) Assignee: Yahoo! Inc., Sunnyvale, CA (US)

(21) Appl. No.: 12/137,493

(22) Filed: Jun. 11, 2008

(51) Int. Cl. G06Q 30/00; G06F 17/30

(52) U.S. Cl. 705/14.25; 707/3; 707/E17.014

(57) ABSTRACT

An improved system and method for previewing search results from a search query is provided. A search results page may provide a preview link selectable by a user to preview text on pages of a website that include terms in the search query. A user may select a preview link for one of the search results, and a request may be sent to the server to preview content of a URL in the search results. In response, the server may return content of web pages of the website that include search terms in the search query. The content may be displayed in a preview window for a user to browse. Furthermore, advertisements may also be served and displayed in the preview window. A user may then browse through the specific context in which the search terms of the query appear and may more effectively find the content desired.

### FIELD OF THE INVENTION

The invention relates generally to computer systems, and more particularly to an improved system and method for a user to preview search results from a search query.

### BACKGROUND OF THE INVENTION

Current search technology may display a search results page that lists multiple websites with relevant information for a search query submitted by a user. In order to find desired content for the search query, a user may select a website to view the content. If the website does not present the desired content, a user may continue to select other websites to view the content or submit another search query to receive a search results page with a different listing of websites to view. Frequently users experience frustration in finding desired content when too many websites are viewed in order to find desired content and when several search queries need to be submitted to find desired content. Although functional, finding the content desired for many search queries presents a challenging task when using the current search technology.

From a user perspective, search engines may often return poor results for certain search queries. Although user interfaces for search queries may explicitly or implicitly expand search terms to help, users often learn good search terms for the desired content by iteratively submitting search terms and receiving results. Such a cyclical process of trial and error can be very inefficient and discouraging for many users. Furthermore, the user interfaces for presenting search results may compound the problem for a user to effectively and efficiently find the desired results. Users are commonly presented with pages and pages of search results that represent an overwhelming space of results to be explored to find desired content. Exploring such a potentially immense results space by iteratively selecting websites to view the content is a rudimentary and cumbersome.

What is needed is a way for a user to efficiently browse through search results of a search query and more effectively find the content desired. Such a system and method should allow users to quickly explore search results in sufficient depth to modify a search query to obtain updated search results if necessary.

### SUMMARY OF THE INVENTION

Briefly, the present invention may provide a system and method for previewing search results from a search query. In various embodiments, a client having a search preview user interface may be operably coupled to a server for requesting to preview content of a web page displayed in the search results page. A search results page may provide a preview link selectable by a user to preview text on pages of a website that include search terms in the search query. The server may include an operably coupled search engine for receiving and responding to search requests, and may also include a search preview engine for receiving and responding to requests to preview a URL in the search results from processing a search query.

The present invention may effectively provide the capability for a user to preview search results from a search query. To do so, a web browser executing on a client computer may receive a search query input by a user and may send the search query request to a server. In response, the server may return search results with preview links to the web browser executing on the client. A user may select a preview link for one of the search results and a request may be sent to the server to preview content of a URL in the search results. In response, the server may return content of web pages of the website that include search terms in the search query. The content may be displayed in a preview window for a user to browse. Furthermore, advertisements may also be served and displayed in the preview window.

Advantageously, the present invention may flexibly allow a user to browse through the specific context in which the search terms of the query appear and may more effectively find the content desired. After previewing search results, a user may refine the search query by modifying or adding search terms to a search query and submitting the modified search query. Or a user may expand the search by modifying or removing terms from a search query and submitting the modified search query. Updated search results may be generated and displayed for a user to preview. Other advantages will become apparent from the following detailed description when taken in conjunction with the drawings, in which:

### BRIEF DESCRIPTION OF THE DRAWINGS

FIG. 1 is a block diagram generally representing a computer system into which the present invention may be incorporated;

FIG. 2 is a block diagram generally representing an exemplary architecture of system components for previewing search results from a search query, in accordance with an aspect of the present invention;

FIG. 3 is an illustration depicting in an embodiment a search results page with preview links displayed on a client device, in accordance with an aspect of the present invention;

FIG. 4 is an illustration depicting a search results page in an embodiment with a search preview web page displayed on a client device, in accordance with an aspect of the present invention;

FIG. 5 is a flowchart generally representing the steps undertaken in one embodiment on a client for previewing search results from a search query, in accordance with an aspect of the present invention; and

FIG. 6 is a flowchart generally representing the steps undertaken in one embodiment on a web page server for providing content for previewing search results from a search query, in accordance with an aspect of the present invention.

### DETAILED DESCRIPTION

### Exemplary Operating Environment

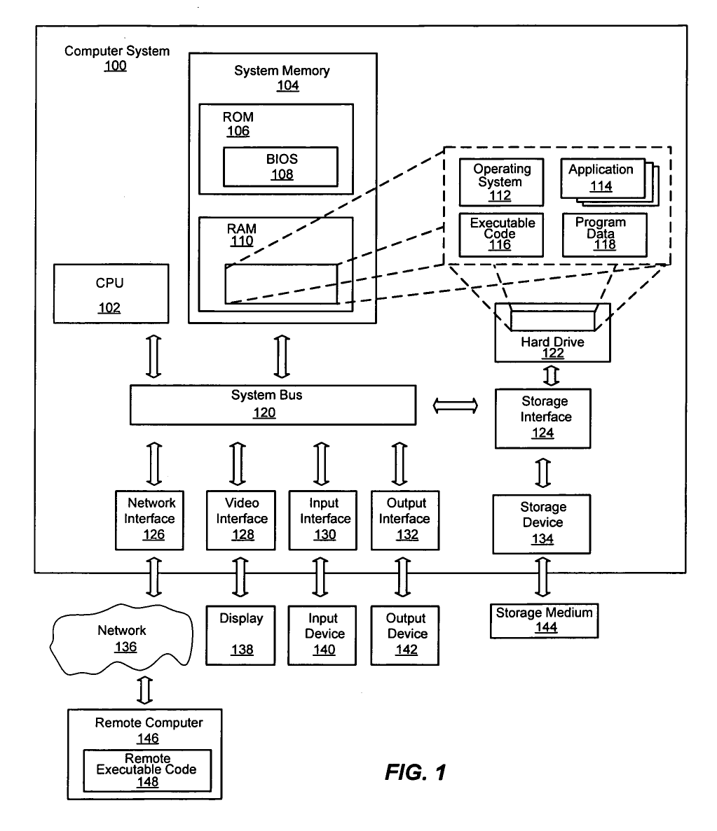

FIG. 1 illustrates suitable components in an exemplary embodiment of a general purpose computing system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computing system environments or configurations.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general purpose computer system 100. Components of the computer system 100 may include, but are not limited to, a CPU or central processing unit 102, a system memory 104, and a system bus 120 that couples various system components including the system memory 104 to the processing unit 102. The system bus 120 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer system 100. Communication media may include computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared and other wireless media.

The system memory 104 includes computer storage media in the form of volatile and/or nonvolatile memory such as read only memory (ROM) 106 and random access memory (RAM) 110. A basic input/output system 108 (BIOS), containing the basic routines that help to transfer information between elements within computer system 100, such as during start-up, is typically stored in ROM 106. Additionally, RAM 110 may contain operating system 112, application programs 114, other executable code 116 and program data 118. RAM 110 typically contains data and/or program modules that are immediately accessible to and/or presently being operated on by CPU 102.

The computer system 100 may also include other removable/non-removable, volatile/nonvolatile computer storage media. By way of example only, FIG. 1 illustrates a hard disk drive 122 that reads from or writes to non-removable, nonvolatile magnetic media, and storage device 134 that may be an optical disk drive or a magnetic disk drive that reads from or writes to a removable, a nonvolatile storage medium 144 such as an optical disk or magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. The hard disk drive 122 and the storage device 134 may be typically connected to the system bus 120 through an interface such as storage interface 124.

The drives and their associated computer storage media, discussed above and illustrated in FIG. 1, provide storage of computer-readable instructions, executable code, data structures, program modules and other data for the computer system 100. In FIG. 1, for example, hard disk drive 122 is illustrated as storing operating system 112, application programs 114, other executable code 116 and program data 118. A user may enter commands and information into the computer system 100 through an input device 140 such as a keyboard and pointing device, commonly referred to as mouse, trackball or touch pad tablet, electronic digitizer, or a microphone. Other input devices may include a joystick, game pad, satellite dish, scanner, and so forth. These and other input devices are often connected to CPU 102 through an input interface 130 that is coupled to the system bus, but may be connected by other interface and bus structures, such as a parallel port, game port or a universal serial bus (USB). A display 138 or other type of video device may also be connected to the system bus 120 via an interface, such as a video interface 128. In addition, an output device 142, such as speakers or a printer, may be connected to the system bus 120 through an output interface 132 or the like computers.

The computer system 100 may operate in a networked environment using a network 136 to one or more remote computers, such as a remote computer 146. The remote computer 146 may be a personal computer, a server, a router, a network PC, a peer device or other common network node, and typically includes many or all of the elements described above relative to the computer system 100. The network 136 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 148 as residing on remote computer 146. It will be appreciated that the network connections shown are exemplary and other means of establishing a communications link between the computers may be used.

Previewing Search Results from a Search Query

The present invention is generally directed towards a system and method for previewing search results from a search query. In general, the present invention may provide the capability for a user to preview contents of search results in a search preview window. When a web browser executing on a client computer may send a search query input by a user to a web server, a web server may return search results with preview links to the web browser executing on the client. A user may select a preview link for one of the search results and content from pages of the website that includes one or more search terms in the search query may be displayed in a search preview window. Thus, a user may be able to preview the specific content of search results that includes the context of the search terms without needing to browse through the website.

As will be seen, relevant advertisements may also be displayed in the search preview window. As will be understood, the various block diagrams, flow charts and scenarios described herein are only examples, and there are many other scenarios to which the present invention will apply.

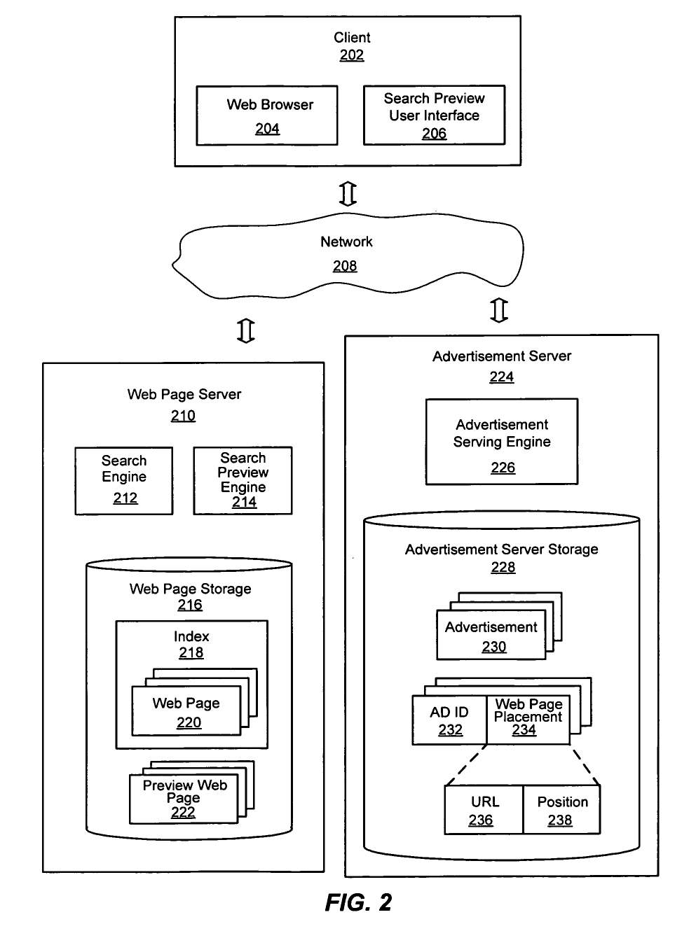

Turning to FIG. 2 of the drawings, there is shown a block diagram generally representing an exemplary architecture of system components for previewing search results from a search query. Those skilled in the art will appreciate that the functionality implemented within the blocks illustrated in the diagram may be implemented as separate components or the functionality of several or all of the blocks may be implemented within a single component. For example, the functionality for the search preview user interface 206 may be included in the same component as the web browser 204. Or the functionality of the search preview user interface 206 may be implemented as a separate component from the web browser 204 as shown. Moreover, those skilled in the art will appreciate that the functionality implemented within the blocks illustrated in the diagram may be executed on a single computer or distributed across a plurality of computers for execution. Moreover, those skilled in the art may also appreciate that the functionality of the present invention may also be implemented using a thin client whereby the functionality of the search preview user interface 206 may be implemented on the server 210. In an embodiment, a web browser 204 may send a request with information about user interaction to the server 210 using an URL with parameters. The request with the URL may be processed by the server, and the server may then send back to the client an HTML document that is ready for display by the web browser 204.

In various embodiments, a client computer 202 may be operably coupled to one or more web page servers 210 and one or more advertisements servers 222 by a network 208. The client computer 202 may be a computer such as computer system 100 of FIG. 1. The network 208 may be any type of network such as a local area network (LAN), a wide area network (WAN), or other type of network. A web browser 204 may execute on the client computer 202 and may include functionality for receiving a search request which may be input by a user entering a query and functionality for sending the query request to a server to obtain a list of search results. The web browser 204 may be operably coupled to a search preview user interface 206 that may include functionality for receiving a request from the web browser for displaying a preview of a URL in the search results. In general, the web browser 204 and the search preview user interface 206 may be any type of interpreted or executable software code such as a kernel component, an application program, a script, a linked library, an object with methods, and so forth.

The web page server 210 may be any type of computer system or computing device such as computer system 100 of FIG. 1. In general, the web page server 210 may provide services for processing a search query and may include services for requesting a list of auctioned advertisements from an advertisement server 222 to be sent to the web browser 204 executing on the client 202 for display with the search results of query processing. In particular, the web page server 210 may include a search engine 212 for receiving and responding to search query requests, and the web page server 210 may also include a search preview engine 214 for receiving and responding to requests to preview a URL in the search results from processing a search query. Each of these modules may also be any type of executable software code such as a kernel component, an application program, a linked library, an object with methods, or other type of executable software code. The web page server 210 may be operably coupled to web page storage 216 that may store an index 218 of crawled web pages 220 that may be searched using keywords of the search query to find web pages that may be provided in the search results. The web page storage may also store preview web pages 222 that provide text on web pages of a website that includes one or more search terms in the search query.

The advertisement server 224 may be any type of computer system or computing device such as computer system 100 of FIG. 1. The advertisement server 224 may provide services for providing a list of advertisements that may be sent to the web browser 204 executing on the client 202 for display with the search results of query processing. The advertisement server 224 may include an advertisement serving engine 226 that may select the list of advertisements and may include functionality to select the list of advertisements using an online keyword auction. The advertisement server 224 may be operably coupled to a database of advertisements such as advertisement server storage 228 that may include any type of advertisements 230 that may be associated with an advertisement ID 232. In an embodiment, an advertisement 230 may be displayed according to a web page placement 234. An advertisement ID 232 associated with an advertisement 230 may be allocated to a web page placement 234 that may include a Uniform Resource Locator (URL) 236 for a web page and a position 238 for displaying an advertisement on the web page. In various embodiments, a web page may be any information that may be addressable by a URL, including a document, an image, audio, and so forth.

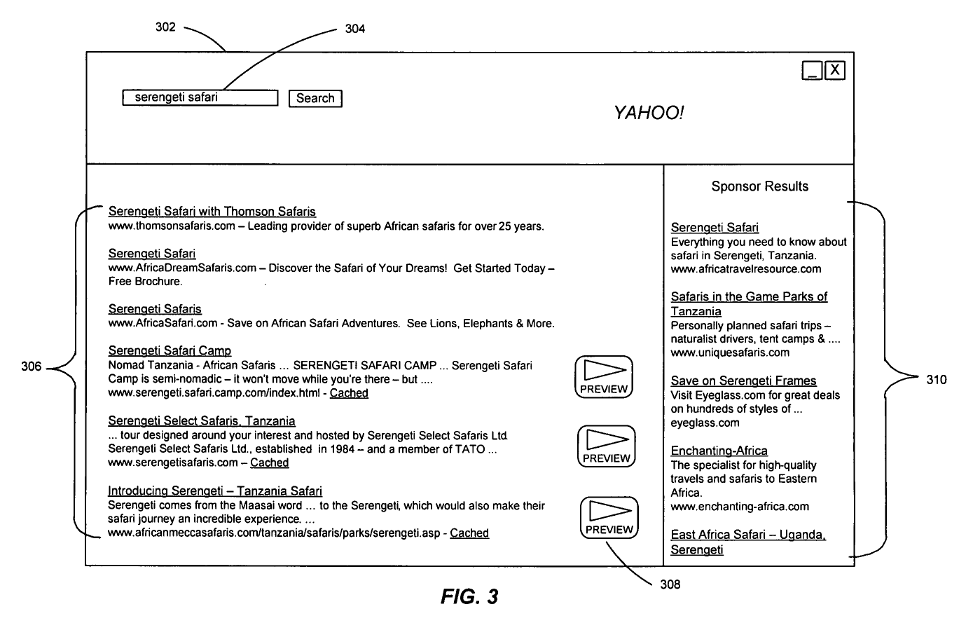

When a user may submit a search query request, the present invention may provide a preview link for each URL in the list of search results. A user may then select a preview link to view a preview web page of content of the associated URL displayed in the search results page. For example, FIG. 3 depicts in an embodiment a search results page with preview links displayed by a web browser running on a client device. A display of a web browser 302 is illustrated in FIG. 3 for a search results page and may include a text input field 304 so a user may enter a search query such as “serengeti safari”. In the embodiment illustrated in FIG. 3 for example, search results such as the list of URLS with descriptive text 306 may be displayed in one area of the search results page and the search results may also include sponsored search advertisements as shown. There may also be sponsored search advertisements such as the list of sponsored search advertisements 310 displayed in another area of the search results page. There may also be a preview link 308 that may be displayed next to one or more search results. A user may select a preview link for display of a preview web page of text on pages of a website that includes one or more search terms in the search query.

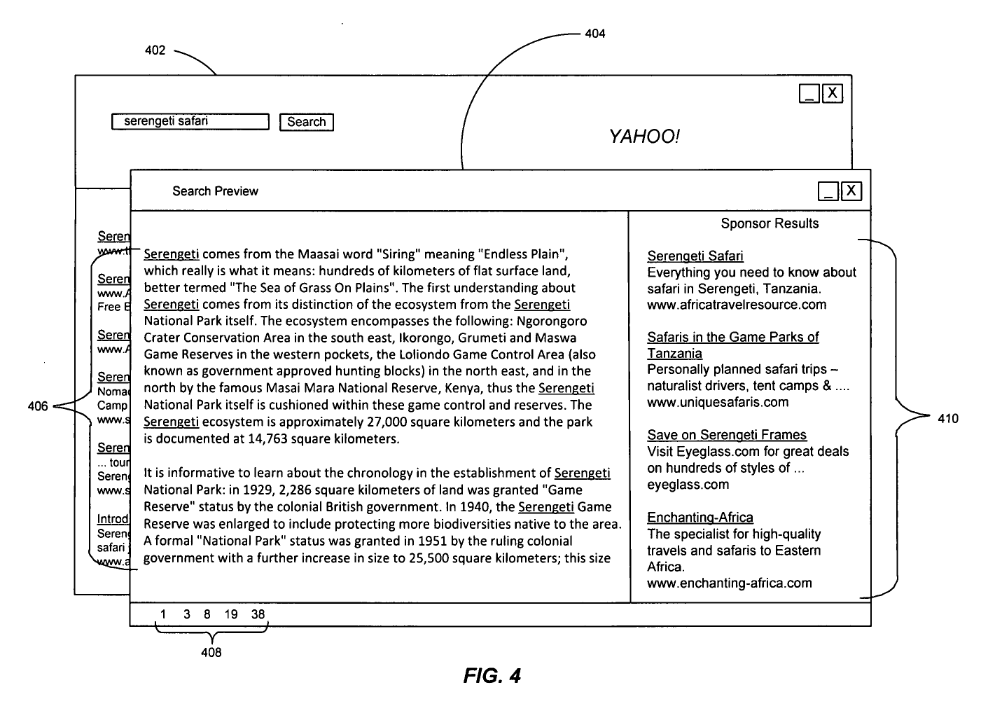

FIG. 4 depicts a search results page in an embodiment with a search preview web page displayed on a client device. A search preview screen 404 displaying the search preview web page is illustrated in FIG. 4 in the foreground, and the display of the search results page by the web browser 402 is shown in the background. In the embodiment illustrated in FIG. 4 for example, pages of a URL that include one or more of the search terms in the search query may be displayed in the display of the search preview web page. For instance, the text 406 displayed in the left area of the search preview screen 404 illustrated in FIG. 4 may represent the text of the first page of a website that includes one or more search terms in the search query. Note that the search terms may be underlined, highlighted, italicized, or visually distinguished in any manner including being displayed using a different font size or type. In particular, the search term “serengeti” is underlined wherever it occurs in the text 406 displayed in the left area of the search preview screen 404. There may also be a list of page numbers 408 of web pages of the website that include one or more search terms in the search query. A user may select a page number from the list of page numbers 408 for display of text of that page with one or more search terms underlined. Thus a user may directly view the context in which the search terms may occur before deciding whether to download the web pages from the URL in the search results.

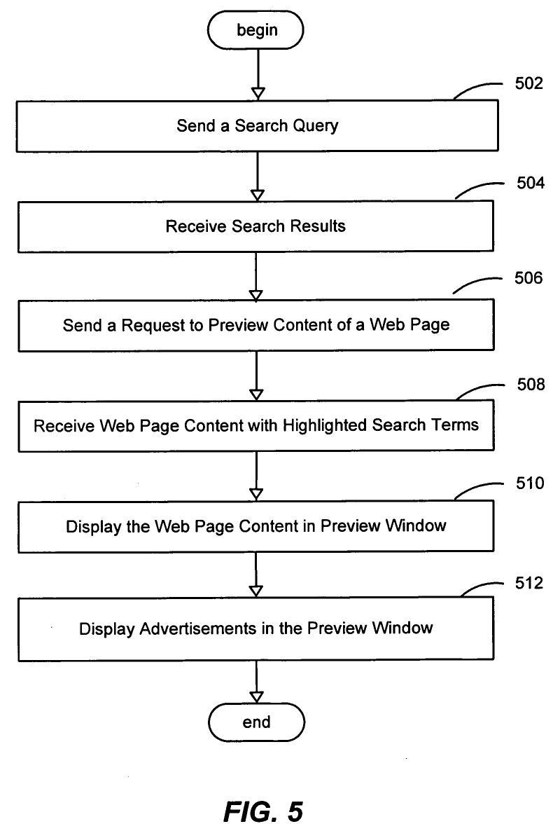

FIG. 5 presents a flowchart generally representing the steps undertaken in one embodiment on a client for previewing search results from a search query. At step 502, a search query may be sent by a client and search results with preview links may be received at step 504. In an embodiment, a web browser executing on a client computer may receive a search query input by a user and may send the search query request to a web server. In response, a web server may return search results with preview links to the web browser executing on the client, and a user may select a preview link for one of the search results. Accordingly, a request may be sent at step 506 to preview content of a web page for a URL in the search results. In an embodiment, a web browser may receive an indication of a user input selecting the preview link and may send a request to a web page server for a search preview web page representing the text of the pages of the website that includes one or more search terms in the search query.

In response, the web page server may return content of web pages of the website that include one or more search terms in the search query. As a result, contents of a web page that includes one or more search terms in the search query may be received at step 508, for instance, by a web browser. At step 510, the content of the web page may be displayed at step 510 in a preview window such as search preview screen 404 illustrated in FIG. 4. And advertisements may be displayed in the preview window at step 512. In an embodiment, a web browser may display the content of the preview web page in a search preview screen and may display advertisement assigned to web page placements in the search preview screen.

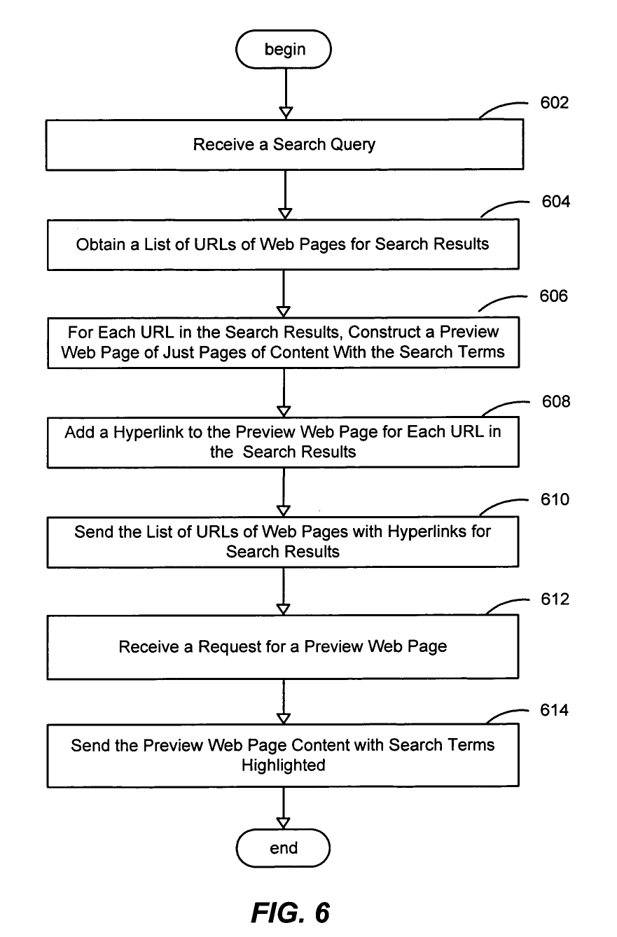

FIG. 6 presents a flowchart generally representing the steps undertaken in one embodiment on a web page server for providing content for previewing search results from a search query. At step 602, a search query from a client may be received by a web server. In response, a list of URLs of web pages may be obtained for search results at step 604. At step 606, a preview web page may be constructed for each URL in the search results. A preview web page may include just pages of content with search terms from a URL. In various embodiments, the contents of the preview web page may be provided in real-time by extracting content of the URL that include one or more search terms in the search query. In any case, a hyperlink with a URL of the preview web page may be added at step 608 for each URL in the search results web page. And a search results page with a list of URLs of web pages with hyperlinks to preview web pages may be sent to a web browser at step 610.

In various embodiments, a web server may send a request to an advertisement server to send advertisements to a web browser to display for web page placements of the search results web page. In other embodiments, a web browser may receive the search results page and request advertisements from an advertisement server.

A web browser may receive an indication of a user input selecting the preview link for one of the search results and may send a request to a web page server for a search preview web page. Accordingly, a request may be received by a web page server at step 612 for a preview web page, and a preview web page may be sent to a client at step 614. In an embodiment, a web page server may send a preview web page that was previously constructed for a URL in the search results. In various embodiments, a web page server may provide the contents of the preview web page in real-time by extracting content of the URL that include one or more search terms in the search query and sending it as requested by a web browser on a client device. For instance, a user may select a page number from the list of page numbers 408 illustrated in FIG. 4 above for display of text of that page with one or more search terms in a search preview screen, and a request to serve content for that page number may be received by a web page server which may extract the content requested and send it to the web browser for display in a preview window such as search preview screen 404 illustrated in FIG. 4.

A web server may also send a request to an advertisement server to send advertisements to a web browser to display for web page placements of the preview web page. In other embodiments, a web browser may receive the preview web page and request advertisements from an advertisement server for web page placements.

Thus the present invention may provide a user interface for a user to previewing search results from a search query. A user may browse through the specific context in which the search terms of the query appear and may more effectively find the content desired. After previewing search results, a user may refine the search query by modifying or adding search terms to a search query and submitting the modified search query. Or a user may expand the search by modifying or removing terms from a search query and submitting the modified search query. Updated search results may be generated and displayed for a user to preview. Those skilled in the art will appreciate that there may be implementations of the search preview window that may include other navigation controls for browsing the context of search terms appearing in search results from a search query.

As can be seen from the foregoing detailed description, the present invention provides an improved system and method for previewing search results from a search query. A user may preview the content of search results that includes the context of the search terms without needing to browse through the website. Additionally, advertisement systems may also send relevant advertisements for display in the search preview window. The system and method may apply broadly to preview any type of textual content including a web page, a website, a document in Portable Document Format (pdf), or other types of textual content. As a result, the system and method provide significant advantages and benefits needed in contemporary computing and in online applications.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A computer system for previewing search results for a query, comprising:
a search preview interface to receive a request to display a preview of content with at least one search term of a search query from a URL in the search results;
a search preview engine operably coupled to the search preview interface to send the preview of content with the at least one search term of the search query from the URL in the search results; and
a web page storage operably coupled to the search preview engine to store a preview web page of content with the at least one search term of the search query from the URL in the search results.

2. The system of claim 1 further comprising the preview web page of content with the at least one search term of the search query from the URL in the search results.

3. The system of claim 1 further comprising a web page server operably coupled to the search preview engine to receive and respond to a search query for search results.

4. The system of claim 1 further comprising a web browser operably coupled to the search preview interface to display the preview of content with the at least one search term of the search query from the URL in the search results.

5. A computer-readable medium having computer-executable components comprising the system of claim 1.

6. A computer-implemented method for previewing search results for a query, comprising:
sending a request from a client device to preview content of a search result listing displayed on a search results page for a search query;
receiving by the client device content of the search result listing that includes at least one of the search terms in the search query; and
displaying the content of the search result listing that includes the at least one of the search terms in a preview window on the client device.

7. The method of claim 6 further comprising receiving at least one advertisement to display in the preview window on the client device.

8. The method of claim 7 further comprising displaying the at least one advertisement in the preview window on the client device.

9. The method of claim 6 further comprising sending the search query from the client device to receive the listing of search results.

10. The method of claim 6 further comprising receiving by the client device the listing of search results with at least one preview link for a search result listing selectable to request the preview of content of the search result listing that includes the at least one of the search terms in the search query.

11. The method of claim 9 further comprising:
obtaining a list of URLs of web pages for search results for the search query; and
constructing a preview web page of content with the at least one search term in the search query for at least one URL in the list of URLs of web pages for search results for the search query.

12. The method of claim 11 further comprising adding a hyperlink to the preview web page for the at least one URL in the list of URLs of web pages for search results for the search query.

13. The method of claim 12 further comprising sending to the client device the list of URLs of web pages with the hyperlink for search results for the search query.

14. The method of claim 13 further comprising receiving the request from the client device to preview content of a search result listing displayed on the search results page for the search query.

15. The method of claim 14 further comprising sending to the client device the preview web page of content with the at least one search term in the search query for at least one URL in the list of URLs of web pages for search results for the search query.

16. A computer-readable medium having computer-executable instructions for performing the method of claim 6.

17. A computer system for previewing search results for a query, comprising:
means for receiving a request to preview content of a web page with at least one search term in a search query for at least one URL in a list of URLs of web pages for search results for the search query;
means for constructing a preview of content of the web page with the at least one search term in the search query for the at least one URL in the list of URLs of web pages for search results for the search query; and
means for sending the preview of content of the web page with the at least one search term in the search query for the at least one URL in the list of URLs of web pages for search results for the search query.

18. The computer system of claim 17 further comprising means for sending search results with a hyperlink to preview content of the web page with the at least one search term in the search query for the at least one URL in the list of URLs of web pages for search results for the search query.

19. The computer system of claim 17 further comprising:
means for requesting by a client device to preview content of the web page with the at least one search term in the search query for the at least one URL in the list of URLs of web pages for search results for the search query;
means for receiving by the client device the preview of content of the web page with the at least one search term in the search query for the at least one URL in the list of URLs of web pages for search results for the search query; and
means for displaying on the client device the preview of content of the web page with the at least one search term in the search query for the at least one URL in the list of URLs of web pages for search results for the search query.

20. The computer system of claim 19 further comprising means for displaying on the client device at least one advertisement with the preview of content of the web page with the at least one search term in the search query for the at least one URL in the list of URLs of web pages for search results for the search query.
